(19) United States
(12) Patent Application Publication
(10) Pub. No.: US 2014/0051816 A9
(43) Pub. Date: Feb. 20, 2014

(54) MULTI-COMPONENT CATALYST SYSTEMS FOR THE PRODUCTION OF REACTOR BLENDS OF POLYPROPYLENE

(71) Applicants: Jun Tian, League City, TX (US); William J. Gauthier, Houston, TX (US); David J. Rauscher, Angleton, TX (US); Nathan Williams, Webster, TX (US)

(72) Inventors: Jun Tian, League City, TX (US); William J. Gauthier, Houston, TX (US); David J. Rauscher, Angleton, TX (US); Nathan Williams, Webster, TX (US)

(73) Assignee: FINA TECHNOLOGY, INC., Houston, TX (US)

(21) Appl. No.: 13/476,133

(22) Filed: May 21, 2012

Related U.S. Application Data
(63) Continuation-in-part of application No. 13/180,672, filed on Jul. 12, 2011.
Application No. 13/180,672 is a division of application No. 11/975,014, filed on Oct. 17, 2007, now Pat. No. 8,003,739.
(60) Provisional application No. 61/497,562, filed on Jun. 16, 2011.

(51) Int. Cl. C08F 4/76; C08F 210/06; C08F 110/06

(52) U.S. Cl. 526/118; 502/152

(57) ABSTRACT

Embodiments of the invention generally include multicomponent catalyst systems, polymerization processes and reactor blends formed by the processes. The multicomponent catalyst system generally includes a first catalyst component selected from an isotactic directing metallocene catalyst. The multicomponent catalyst system further includes a second syndiotactic directing metallocene catalyst component.

### CROSS-REFERENCE TO RELATED APPLICATIONS

This application claims priority to U.S. Provisional Patent No. 61/497,562 filed on Jun. 16, 2011.

### FIELD

Embodiments of the present invention generally relate to processes and catalyst systems for forming polyolefins. In particular, embodiments relate to multicomponent catalyst systems for forming blends of polypropylene in-situ. Specifically, embodiments relate to multicomponent catalyst systems for forming reactor blends of isotactic polypropylene and syndiotactic polypropylene.

### BACKGROUND

Metallocene compounds, whether supported or unsupported, can further be characterized in terms of stereoregular catalysts which can facilitate the polymerization of alpha olefins, such as propylene, to produce crystalline stereoregular polymers, the most common of which are isotactic polypropylene and syndiotactic polypropylene. In general, stereospecific metallocene catalysts possess a center structure and one or more ligand structures (usually cyclopentadienyl-based) that are conformationally restricted. The center structure of stereospecific metallocene catalysts is typically chiral in conformation. A chiral object is not superimposible on its mirror image, examples of chiral objects include hands and keys.

Isospecific and syndiospecific metallocene catalysts can be useful in the stereospecific polymerization of monomers. Stereospecific structural relationships of syndiotacticity and isotacticity may be involved in the formation of stereoregular polymers from various monomers. Stereospecific propagation may be applied in the polymerization of ethylenically unsaturated monomers such as C₃ to C₂₀ alpha olefins which can be linear, branched, or cyclic, 1-dienes such as 1,3-butadiene, substituted vinyl compounds such as vinyl aromatics, e.g., styrene or vinyl chloride, vinyl chloride, vinyl ethers such as alkyl vinyl ethers, e.g., isobutyl vinyl ether, or even aryl vinyl ethers. Stereospecific polymer propagation is probably of most significance in the production of polypropylene of isotactic or syndiotactic structure.

The structure of isotactic polypropylene can be described as one having the methyl groups attached to the tertiary carbon atoms of successive monomeric units falling on the same side of a hypothetical plane through the main chain of the polymer, e.g., the methyl groups are all above or below the plane. Using the Fischer projection formula, the stereochemical sequence of isotactic polypropylene can be described as follows:

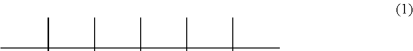

In Formula 1 each vertical segment indicates a methyl group on the same side of the polymer backbone. In the case of isotactic polypropylene, the majority of inserted propylene units possess the same relative configuration in relation to its neighboring propylene unit. Another way of describing the structure is through the use of NMR. Bovey's NMR nomenclature for an isotactic sequence as shown above is . . . mmmm . . . with each “m” representing a “meso” dyad in which there is a mirror plane of symmetry between two adjacent monomer units, or successive pairs of methyl groups on the same side of the plane of the polymer chain. As is known in the art, any deviation or inversion in the structure of the chain lowers the degree of isotacticity and subsequently the crystallinity of the polymer.

In contrast to the isotactic structure, syndiotactic propylene polymers are those in which the methyl groups attached to the tertiary carbon atoms of successive monomeric units in the chain lie on alternate sides of the plane of the polymer. Syndiotactic polypropylene in using the Fischer projection formula can be indicated by racemic dyads with the syndiotactic sequence . . . rrrr . . . shown as follows:

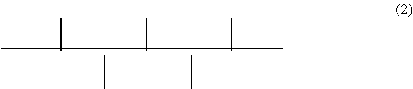

Bovey's NMR nomenclature for a syndiotactic sequence as shown above is . . . rrrr . . . with each “r” representing a “racemic” dyad in which successive pairs of methyl groups are on the opposite sides of the plane of the polymer chain. Similarly, any deviation or inversion in the structure of the chain lowers the degree of syndiotacticity and subsequently the crystallinity of the polymer.

The vertical segments in the preceding example indicate methyl groups in the case of syndiotactic or isotactic polypropylene. Other terminal groups, e.g. ethyl, in the case of polyl-butene, chloride, in the case of polyvinyl chloride, or phenyl groups in the case of polystyrene and so on can be equally described in this fashion as either isotactic or syndiotactic.

A polymer is “atactic” when its pendant groups are arranged in a random fashion on both sides of the chain of the polymer.

Metallocene catalyzed isotactic polypropylene (miPP) has a high fiber spinning speed, mainly thanks to its narrow molecular weight distribution. Studies have shown that syndiotactic polypropylene (sPP) processabilty can be improved without sacrificing intrinsic properties of sPP via melt blending with up to 15 wt % miPP. Moreover, miPP/sPP blends in fibers may provide final materials having better softness and thermal bonding characteristics, and still provide for good spinning speed.

Therefore, a need exists for a process of producing a miPP/sPP blend without requiring an additional melt blending process of the two polymers.

### SUMMARY

Embodiments of the invention generally include multicomponent catalyst systems. The multicomponent catalyst system generally includes a first catalyst component selected from a metallocene catalyst represented by the general formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4. The multicomponent catalyst system further includes a second catalyst component generally represented by the formula XCp^{A} Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4.

One embodiment includes a process further including introducing the multicomponent catalyst system to a reaction zone, introducing an olefin monomer to the reaction zone and contacting the multicomponent catalyst system with the olefin monomer to form a polyolefin.

Embodiments further include the resulting reaction blend polymer which comprises both metallocene isotactic polypropylene and syndiotactic polypropylene formed by the processes described herein.

In one embodiment, the first catalyst component includes an isotactic directing metallocene catalyst. In one embodiment, the second catalyst component includes a syndiotactic directing metallocene catalyst.

### BRIEF DESCRIPTION OF DRAWINGS

FIG. 1 illustrates the analysis of the compositions of the miPP/sPP reactor blends by ¹³C NMR and DSC.

FIG. 2 illustrates a comparison of the propylene polymerization activity between TEA1 and TiBA1 as the scavengers at 2.0 wt % total loading, bulk with 60 mg. scavengers and 60° C.

FIG. 3 illustrates a comparison of the polymer fluff between TEA1 and TiBA1 as the scavengers at 2.0 wt % total loading, bulk with 60 mg. scavengers and 60° C.

FIG. 4 provides the DSC composition analysis of miPP/sPP with TEA1 and TiBA1 as the scavengers at 2.0 wt % total loading, bulk with 60 mg. scavengers and 60° C.

FIG. 5 provides the DSC profiles of miPP/sPP reactor blends from P10-supported catalysts with different m:MC6 weight ratios.

FIG. 6 provides the DSC profiles of miPP/sPP reactor blends from P10-supported catalysts with different metallocene loadings.

FIG. 7 provides the DSC profiles of miPP/sPP reactor blends from H121c-supported catalysts with different m:MC6 weight ratios.

FIG. 8 provides the DSC profiles of miPP/sPP reactor blends from H121c-supported catalysts with different metallocene loadings.

FIG. 9 provides ¹³C NMR dyads results of miPP/sPP reactor blends from P-10-supported catalysts with different m:MC6 weight ratios.

FIG. 10 provides ¹³C NMR pentads results of miPP/sPP reactor blends from P-10-supported catalysts with different m:MC6 weight ratios.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

The term “activity” refers to the weight of product produced per weight of the catalyst used in a process at a standard set of conditions per unit time.

As used herein, the term “activator” is defined to be any compound or combination of compounds, supported or unsupported, which may enhance the activity and/or productivity of a catalyst compound.

### Catalyst Systems

Certain polymerization processes disclosed herein involve contacting olefin monomers with a multicomponent catalyst composition, sometimes also referred to herein as simply a multicomponent catalyst. As used herein, the terms “multicomponent catalyst composition” and “multicomponent catalyst” refer to any composition, mixture or system that includes at least two different catalyst compounds. Although it is contemplated that the multicomponent catalyst can include more than two different catalysts, for purposes of discussing the invention herein, only two of those catalyst compounds are described in detail herein (i.e., the “first catalyst component” and the “second catalyst component”).

### First Catalyst Component

The multicomponent catalyst compositions described herein include a “first catalyst component”. The first catalyst component generally includes catalyst systems known to one skilled in the art. For example, the first catalyst component may include metallocene catalyst systems, single site catalyst systems, or combinations thereof, for example. A brief discussion of such catalyst systems is included below, but is in no way intended to limit the scope of the invention to such catalysts.

Metallocene catalysts may be characterized generally as coordination compounds incorporating one or more cyclopentadienyl (Cp) groups (which may be substituted or unsubstituted, each substitution being the same or different) coordinated with a transition metal through π bonding.

The substituent groups on Cp may be linear, branched or cyclic hydrocarbyl radicals, for example. The inclusion of cyclic hydrocarbyl radicals may transform the Cp into other contiguous ring structures, such as indenyl, azulenyl and fluorenyl groups, for example. These contiguous ring structures may also be substituted or unsubstituted by hydrocarbyl radicals, such as C₁ to C₂₀ hydrocarbyl radicals, for example.

A specific, non-limiting, example of a metallocene catalyst is a bulky ligand metallocene compound generally represented by the formula:

[L]ₘM[A]ₙ;

wherein L is a bulky ligand, A is a leaving group, M is a transition metal and m and n are such that the total ligand valency corresponds to the transition metal valency. For example m may be from 1 to 4 and n may be from 1 to 3.

The metal atom “M” of the metallocene catalyst compound, as described throughout the specification and claims, may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni. The oxidation state of the metal atom “M” may range from 0 to +7 or is +1, +2, +3, +4 or +5, for example.

The bulky ligand generally includes a cyclopentadienyl group (Cp) or a derivative thereof. The Cp ligand(s) form at least one chemical bond with the metal atom M to form the “metallocene catalyst.” The Cp ligands are distinct from the leaving groups bound to the catalyst compound in that they are not highly susceptible to substitution/abstraction reactions.

Cp ligands may include ring(s) or ring system(s) including atoms selected from group 13 to 16 atoms, such as carbon, nitrogen, oxygen, silicon, sulfur, phosphorous, germanium, boron, aluminum and combinations thereof, wherein carbon makes up at least 50% of the ring members. Non-limiting examples of the ring or ring systems include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or “H₄Ind”), substituted versions thereof and heterocyclic versions thereof, for example.

Cp substituent groups may include hydrogen radicals, alkyls (e.g., methyl, ethyl, propyl, butyl, pentyl, hexyl, fluoromethyl, fluoroethyl, difluoroethyl, iodopropyl, bromohexyl, benzyl, phenyl, methylphenyl, tert-butylphenyl, chlorobenzyl, dimethylphosphine and methylphenylphosphine), alkenyls (e.g., 3-butenyl, 2-propenyl and 5-hexenyl), alkynyls, cycloalkyls (e.g., cyclopentyl and cyclohexyl), aryls (e.g., trimethylsilyl, trimethylgermyl, methyldiethylsilyl, acyls, aroyls, tris(trifluoromethyl)silyl, methylbis(difluoromethyl)silyl and bromomethyldimethylgermyl), alkoxys (e.g., methoxy, ethoxy, propoxy and phenoxy), aryloxys, alkylthiols, dialkylamines (e.g., dimethylamine and diphenylamine), alkylamidos, alkoxycarbonyls, aryloxycarbonyls, carbomoyls, alkyl- and dialkyl-carbamoyls, acyloxys, acylaminos, aroylaminos, organometalloid radicals (e.g., dimethylboron), Group 15 and Group 16 radicals (e.g., methylsulfide and ethylsulfide) and combinations thereof, for example. In one embodiment, at least two substituent groups, two adjacent substituent groups in one embodiment, are joined to form a ring structure.

Each leaving group “A” is independently selected and may include any ionic leaving group, such as halogens (e.g., chloride and fluoride), hydrides, C₁ to C₁₂ alkyls (e.g., methyl, ethyl, propyl, phenyl, cyclobutyl, cyclohexyl, heptyl, tolyl, trifluoromethyl, methylphenyl, dimethylphenyl and trimethylphenyl), C₂ to C₁₂ alkenyls (e.g., C₂ to C₆ fluoroalkenyls), C₆ to C₁₂ aryls (e.g., C₇ to C₂₀ alkylaryls), C₁ to C₁₂ alkoxys (e.g., phenoxy, methyoxy, ethyoxy, propoxy and benzoxy), C₆ to C₁₆ aryloxys, C₇ to C₁₈ alkylaryloxys and C₁ to C₁₂ heteroatom-containing hydrocarbons and substituted derivatives thereof, for example.

Other non-limiting examples of leaving groups include amines, phosphines, ethers, carboxylates (e.g., C₁ to C₆ alkylcarboxylates, C₆ to C₁₂ arylcarboxylates and C₇ to C₁₈ alkylarylcarboxylates), dienes, alkenes (e.g., tetramethylene, pentamethylene, methylidene), hydrocarbon radicals having from 1 to 20 carbon atoms (e.g., pentafluorophenyl) and combinations thereof, for example. In one embodiment, two or more leaving groups form a part of a fused ring or ring system.

In a specific embodiment, L and A may be bridged to one another to form a bridged metallocene catalyst. A bridged metallocene catalyst, for example, may be described by the general formula:

XCp^{A}Cp^{B}MAₙ;

wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4, and either 1 or 2 in a particular embodiment.

Non-limiting examples of bridging groups “X” include divalent hydrocarbon groups containing at least one Group 13 to 16 atom, such as, but not limited to, at least one of a carbon, oxygen, nitrogen, silicon, aluminum, boron, germanium, tin and combinations thereof; wherein the heteroatom may also be a C₁ to C₁₂ alkyl or aryl group substituted to satisfy a neutral valency. The bridging group may also contain substituent groups as defined above including halogen radicals and iron. More particular non-limiting examples of bridging group are represented by C₁ to C₆ alkylenes, substituted C₁ to C₆ alkylenes, oxygen, sulfur, R₂C═, R₂Si═, —Si(R)₂Si(R₂)—, R₂Ge═ or RP═ (wherein “═” represents two chemical bonds), where R is independently selected from hydrides, hydrocarbyls, halocarbyls, hydrocarbyl-substituted organometalloids, halocarbyl-substituted organometalloids, disubstituted boron atoms, disubstituted Group 15 atoms, substituted Group 16 atoms and halogen radicals, for example. In one embodiment, the bridged metallocene catalyst component has two or more bridging groups.

Other non-limiting examples of bridging groups include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties, wherein the Si atom is replaced by a Ge or a C atom; dimethylsilyl, diethylsilyl, dimethylgermyl and/or diethylgermyl.

In another embodiment, the bridging group may also be cyclic and include 4 to 10 ring members or 5 to 7 ring members, for example. The ring members may be selected from the elements mentioned above and/or from one or more of boron, carbon, silicon, germanium, nitrogen and oxygen, for example. Non-limiting examples of ring structures which may be present as or part of the bridging moiety are cyclobutylidene, cyclopentylidene, cyclohexylidene, cycloheptylidene, cyclooctylidene, for example. The cyclic bridging groups may be saturated or unsaturated and/or carry one or more substituents and/or be fused to one or more other ring structures. The one or more Cp groups which the above cyclic bridging moieties may optionally be fused to may be saturated or unsaturated. Moreover, these ring structures may themselves be fused, such as, for example, in the case of a naphthyl group.

In one embodiment, the metallocene catalyst includes CpFlu Type catalysts (e.g., a metallocene catalyst wherein the ligand includes a Cp fluorenyl ligand structure) represented by the following formula:

X(CpR¹ₙR²ₘ)(F1R³ₚ);

wherein Cp is a cyclopentadienyl group or derivatives thereof, F1 is a fluorenyl group, X is a structural bridge between Cp and F1, R¹ is an optional substituent on the Cp, n is 1 or 2, R² is an optional substituent on the Cp bound to a carbon immediately adjacent to the ipso carbon, m is 1 or 2 and each R³ is optional, may be the same or different and may be selected from C₁ to C₂₀ hydrocarbyls. In one embodiment, at least one R³ is substituted in the para position on the fluorenyl group and at least one other R³ being substituted at an opposed para position on the fluorenyl group and p is 2 or 4.

In yet another aspect, the metallocene catalyst includes bridged mono-ligand metallocene compounds (e.g., mono cyclopentadienyl catalyst components). In this embodiment, the metallocene catalyst is a bridged “half-sandwich” metallocene catalyst. In yet another aspect of the invention, the at least one metallocene catalyst component is an unbridged “half sandwich” metallocene. (See, U.S. Pat. No. 6,069,213, U.S. Pat. No. 5,026,798, U.S. Pat. No. 5,703,187, U.S. Pat. No. 5,747,406, U.S. Pat. No. 5,026,798 and U.S. Pat. No. 6,069,213, which are incorporated by reference herein.)

Non-limiting examples of metallocene catalyst components consistent with the description herein include, for example cyclopentadienylzirconiumAₙ; indenylzirconiumAₙ; (1-methylindenyl)zirconiumAₙ; (2-methylindenyl)zirconiumAₙ, (1-propylindenyl)zirconiumAₙ; (2-propylindenyl)zirconiumAₙ; (1-butylindenyl)zirconiumAₙ; (2-butylindenyl)zirconiumAₙ; methylcyclopentadienylzirconiumAₙ; tetrahydroindenylzirconiumAₙ; pentamethylcyclopentadienylzirconiumAₙ; cyclopentadienylzirconiumAₙ; pentamethylcyclopentadienyltitaniumAₙ; tetramethylcyclopentyltitaniumAₙ; (1,2,4-trimethylcyclopentadienyl)zirconiumAₙ; dimethylsilyl(1,2,3,4-tetramethylcyclopentadienyl)(cyclopentadienyl)zirconiumAₙ; dimethylsilyl(1,2,3,4-tetramethylcyclopentadienyl)(1,2,3-trimethylcyclopentadienyl)zirconiumAₙ; dimethylsilyl(1,2,3,4-tetramethylcyclopentadienyl)(1,2-dimethylcyclopentadienyl)zirconiumAₙ; dimethylsilyl(1,2,3,4-tetramethylcyclopentadienyl)(2-methylcyclopentadienyl)zirconiumAₙ; dimethylsilylcyclopentadienylindenylzirconiumAₙ; dimethylsilyl(2-methylindenyl)(fluorenyl)zirconiumAₙ; diphenylsilyl(1,2,3,4-tetramethylcyclopentadienyl)(3-propylcyclopentadienyl)zirconiumAₙ; dimethylsilyl (1,2,3,4-tetramethylcyclopentadienyl)(3-t-butylcyclopentadienyl)zirconiumAₙ; dimethylgermyl(1,2-dimethylcyclopentadienyl)(3-isopropylcyclopentadienyl)zirconiumAₙ; dimethylsilyl(1,2,3,4-tetramethylcyclopentadienyl)(3-methylcyclopentadienyl)zirconiumAₙ; diphenylmethylidene(cyclopentadienyl)(9-fluorenyl)zirconiumAₙ; diphenylmethylidenecyclopentadienylindenylzirconiumAₙ; isopropylidenebiscyclopentadienylzirconiumAₙ; isopropylidene(cyclopentadienyl)(9-fluorenyl)zirconiumAₙ; isopropylidene(3-methylcyclopentadienyl)(9-fluorenyl)zirconiumAₙ; ethylenebis(9-fluorenyl)zirconiumAₙ; ethylenebis(1-indenyl)zirconiumAₙ; ethylenebis(1-indenyl)zirconiumAₙ; ethylenebis(2-methyl-1-indenyl)zirconiumAₙ; ethylenebis(2-methyl-4,5,6,7-tetrahydro-1-indenyl)zirconiumAₙ; ethylenebis(2-propyl-4,5,6,7-tetrahydro-1-indenyl)zirconiumAₙ; ethylenebis(2-isopropyl-4,5,6,7-tetrahydro-1-indenyl)zirconiumAₙ; ethylenebis(2-butyl-4,5,6,7-tetrahydro-1-indenyl)zirconiumAₙ; ethylenebis(2-isobutyl-4,5,6,7-tetrahydro-1-indenyl)zirconiumAₙ; dimethylsilyl(4,5,6,7-tetrahydro-1-indenyl)zirconiumAₙ; diphenyl(4,5,6,7-tetrahydro-1-indenyl)zirconiumAₙ; ethylenebis(4,5,6,7-tetrahydro-1-indenyl)zirconiumAₙ; dimethylsilylbis(cyclopentadienyl)zirconiumAₙ; dimethylsilylbis(9-fluorenyl)zirconiumAₙ; dimethylsilylbis(1-indenyl)zirconiumAₙ; dimethylsilylbis(2-methylindenyl)zirconiumAₙ; dimethylsilylbis(2-propylindenyl)zirconiumAₙ; dimethylsilylbis(2-butylindenyl)zirconiumAₙ; diphenylsilylbis(2-methylindenyl)zirconiumAₙ; diphenylsilylbis(2-propylindenyl)zirconiumAₙ; diphenylsilylbis(2-butylindenyl)zirconiumAₙ; dimethylgermylbis(2-methylindenyl)zirconiumAₙ; dimethylsilylbistetrahydroindenylzirconiumAₙ; dimethylsilylbistetramethylcyclopentadienylzirconiumAₙ; dimethylsilyl(cyclopentadienyl)(9-fluorenyl)zirconiumAₙ; diphenylsilyl(cyclopentadienyl)(9-fluorenyl)zirconiumAₙ; diphenylsilylbisindenylzirconiumAₙ; cyclotrimethylenesilyltetramethylcyclopentadienylcyclopentadienylzirconiumAₙ; cyclotetramethylenesilyltetramethylcyclopentadienylcyclopentadienylzirconiumAₙ; cyclotrimethylenesilyktetramethylcyclopentadienyl)(2-methylindenyl)zirconiumAₙ; cyclotrimethylenesilyktetramethylcyclopentadienyl)(3-methylcyclopentadienyl)zirconiumAₙ; cyclotrimethylenesilylbis(2-methylindenyl)zirconiumAₙ; cyclotrimethylenesilyl(tetramethylcyclopentadienyl)(2,3,5-trimethylclopentadienyl)zirconiumAₙ; cyclotrimethylenesilylbis(tetramethylcyclopentadienyl)zirconiumAₙ; dimethylsilyktetramethylcyclopentadieneyl)(N-tertbutylamido)titaniumAₙ; biscyclopentadienylchromiumAₙ; biscyclopentadienylzirconiumAₙ; bis(n-butylcyclopentadienyl)zirconiumAₙ; bis(n-dodecyclcyclopentadienyl)zirconiumAₙ; bisethylcyclopentadienylzirconiumAₙ; bisisobutylcyclopentadienylzirconiumAₙ; bisisopropylcyclopentadienylzirconiumAₙ; bismethylcyclopentadienylzirconiumAₙ; bisoctylcyclopentadienylzirconiumAₙ; bis(n-pentylcyclopentadienyl)zirconiumAₙ; bis(n-propylcyclopentadienyl)zirconiumAₙ; bistrimethylsilylcyclopentadienylzirconiumAₙ; bis(1,3-bis(trimethylsilyl)cyclopentadienyl)zirconiumAₙ; bis(1-ethyl-2-methylcyclopentadienyl)zirconiumAₙ; bis(1-ethyl-3-methylcyclopentadienyl)zirconiumAₙ; bispentamethylcyclopentadienylzirconiumAₙ; bispentamethylcyclopentadienylzirconiumAₙ; bis(1-propyl-3-methylcyclopentadienyl)zirconiumAₙ; bis(1-n-butyl-3-methylcyclopentadienyl)zirconiumAₙ; bis(1-isobutyl-3-methylcyclopentadienyl)zirconiumAₙ; bis(1-propyl-3-butylcyclopentadienyl)zirconiumAₙ; bis(1,3-n-butylcyclopentadienyl)zirconiumAₙ; bis(4,7-dimethylindenyl)zirconiumAₙ; bisindenylzirconiumAₙ; bis(2-methylindenyl)zirconiumAₙ; cyclopentadienylindenylzirconiumAₙ; bis(n-propylcyclopentadienyl)hafniumAₙ; bis(n-butylcyclopentadienyl)hafniumAₙ; bis(n-pentylcyclopentadienyl)hafniumAₙ; (n-propylcyclopentadienyl)(n-butylcyclopentadienyl)hafniumAₙ; bis[(2-trimethylsilylethyl)cyclopentadienyl]hafniumAₙ; bis(trimethylsilylcyclopentadienyl)hafniumAₙ; bis(2-n-propylindenyl)hafniumAₙ; bis(2-n-butylindenyl)hafniumAₙ; dimethylsilylbis(n-propylcyclopentadienyl)hafniumAₙ; dimethylsilylbis(n-butylcyclopentadienyl)hafniumAₙ; bis(9-n-propylfluorenyl)hafniumAₙ; bis(9-n-butylfluorenyl)hafniumAₙ; (9-n-propylfluorenyl)(2-n-propylindenyl)hafniumAₙ; bis(1-n-propyl-2-methylcyclopentadienyl)hafniumAₙ; (n-propylcyclopentadienyl)(1-n-propyl-3-n-butylcyclopentadienyl)hafniumAₙ; dimethylsilyltetramethylcyclopentadienylcyclopropylamidotitaniumAₙ; dimethylsilyltetramethyleyclopentadienylcyclobutylamidotitaniumAₙ; dimethylsilyltetramethyleyclopentadienylcyclopentylamidotitaniumAₙ; dimethylsilyltetramethylcyclopentadienylcyclohexylamidotitaniumAₙ; dimethylsilyltetramethylcyclopentadienylcycloheptylamidotitaniumAₙ; dimethylsilyltetramethylcyclopentadienylcyclooctylamidotitaniumAₙ; dimethylsilyltetramethylcyclopentadienylcyclononylamidotitaniumAₙ; dimethylsilyltetramethylcyclopentadienylcyclodecylamidotitaniumAₙ; dimethylsilyltetramethylcyclopentadienylcycloundecylamidotitaniumAₙ; dimethylsilyltetramethylcyclopentadienylcyclododecylamidotitaniumAₙ; dimethylsilyltetramethylcyclopentadienyl(sec-butylamido)titaniumAₙ; dimethylsilyktetramethylcyclopentadienyl)(n-octylamido)titaniumAₙ; dimethylsilyktetramethylcyclopentadienyl)(n-decylamido)titaniumAₙ; dimethylsilyktetramethylcyclopentadienyl)(n-octadecylamido)titaniumAₙ; dimethylsilylbis(cyclopentadienyl)zirconiumAₙ; dimethylsilylbis(tetramethylcyclopentadienyl)zirconiumAₙ; dimethylsilylbis(methylcyclopentadienyl)zirconiumAₙ; dimethylsilylbis(dimethylcyclopentadienyl)zirconiumAₙ; dimethylsilyl(2,4-dimethylcyclopentadienyl)(3′,5′-dimethylcyclopentadienyl)zirconiumAₙ; dimethylsilyl(2,3,5-trimethylcyclopentadienyl)(2′,4′,5′-dimethylcyclopentadienyl)zirconiumAₙ; dimethylsilylbis(t-butylcyclopentadienyl)zirconiumAₙ; dimethylsilylbis(trimethylsilylcyclopentadienyl)zirconiumAₙ; dimethylsilylbis(2-trimethylsilyl-4-t-butylcyclopentadienyl)zirconiumAₙ; dimethylsilylbis(4,5,6,7-tetrahydro-indenyl)zirconiumAₙ; dimethylsilylbis(indenyl)zirconiumAₙ; dimethylsilylbis(2-methylindenyl)zirconiumAₙ; dimethylsilylbis(2,4-dimethylindenyl)zirconiumAₙ; dimethylsilylbis(2,4,7-trimethylindenyl)zirconiumAₙ; dimethylsilylbis(2-methyl-4-phenylindenyl)zirconiumAₙ; dimethylsilylbis(2-ethyl-4-phenylindenyl)zirconiumAₙ; dimethylsilylbis(benz[e]indenyl)zirconiumAₙ; dimethylsilylbis(2-methylbenz[e]indenyl)zirconiumAₙ; dimethylsilylbis(benz[f]indenyl)zirconiumAₙ; dimethylsilylbis(2-methylbenz[f]indenyl)zirconiumAₙ; dimethylsilylbis(3-methylbenz[f]indenyl)zirconiumAₙ; dimethylsilylbis(cyclopenta[cd]indenyl)zirconiumAₙ; dimethylsilylbis(cyclopentadienyl)zirconiumAₙ; dimethylsilylbis(tetramethylcyclopentadienyl)zirconiumAₙ; dimethylsilylbis(methylcyclopentadienyl)zirconiumAₙ; dimethylsilylbis(dimethylcyclopentadienyl)zirconiumAₙ; isopropylidene(cyclopentadienyl-fluorenyl)zirconiumAₙ; isopropylidene(cyclopentadienyl-indenyl)zirconiumAₙ; isopropylidene(cyclopentadienyl-2,7-di-t-butylfluorenyl)zirconiumAₙ; isopropylidene(cyclopentadienyl-3-methylfluorenyl)zirconiumAₙ; isoropylidene(cyclopentadienyl-4-methylfluorenyl)zirconiumAₙ; isopropylidene(cyclopentadienyl-octahydrofluorenyl)zirconiumAₙ; isopropylidene(methylcyclopentadienyl-fluorenyl)zirconiumAₙ; isopropylidene(dimethylcyclopentadienylfluorenyl)zirconiumAₙ; isopropylidene(tetramethylcyclopentadienyl-fluorenyl)zirconiumAₙ; diphenylmethylene(cyclopentadienyl-fluorenyl)zirconiumAₙ; diphenylmethylene(cyclopentadienyl-indenyl)zirconiumAₙ; diphenylmethylene(cyclopentadienyl-2,7-di-t-butylfluorenyl)zirconiumAₙ; diphenylmethylene(cyclopentadienyl-3-methylfluorenyl)zirconiumAₙ; diphenylmethylene(cyclopentadienyl-4-methylfluorenyl)zirconiumAₙ; diphenylmethylene(cyclopentadienyloctahydrofluorenyl)zirconiumAₙ; diphenylmethylene(methylcyclopentadienyl-fluorenyl)zirconiumAₙ; diphenylmethylene(dimethylcyclopentadienyl-fluorenyl)zirconiumAₙ; diphenylmethylene(tetramethylcyclopentadienyl-fluorenyl)zirconiumAₙ; cyclohexylidene(cyclopentadienyl-fluorenyl)zirconiumAₙ; cyclohexylidene(cyclopentadienylindenyl)zirconiumAₙ; cyclohexylidene(cyclopentadienyl-2,7-di-t-butylfluorenyl)zirconiumAₙ; cyclohexylidene(cyclopentadienyl-3-methylfluorenyl)zirconiumAₙ; cyclohexylidene(cyclopentadienyl-4-methylfluorenyl)zirconiumAₙ; cyclohexylidene(cyclopentadienyloctahydrofluorenyl)zirconiumAₙ; cyclohexylidene(methylcyclopentadienylfluorenyl)zirconiumAₙ; cyclohexylidene(dimethylcyclopentadienyl-fluorenyl)zirconiumAₙ; cyclohexylidene(tetramethylcyclopentadienylfluorenyl)zirconiumAₙ; dimethylsilyl(cyclopentadienyl-fluorenyl)zirconiumAₙ; dimethylsilyl(cyclopentadienyl-indenyl)zirconiumAₙ; dimethylsilyl(cyclopentdienyl-2,7-di-t-butylfluorenyl)zirconiumAₙ; dimethylsilyl(cyclopentadienyl-3-methylfluorenyl)zirconiumAₙ; dimethylsilyl(cyclopentadienyl-4-methylfluorenyl)zirconiumAₙ; dimethylsilyl(cyclopentadienyl-octahydrofluorenyl)zirconiumAₙ; dimethylsilyl(methylcyclopentanedienyl-fluorenyl)zirconiumAₙ; dimethylsilyl(dimethylcyclopentadienylfluorenyl)zirconiumAₙ; dimethylsilyl(tetramethylcyclopentadienylfluorenyl)zirconiumAₙ; isopropylidene(cyclopentadienyl-fluorenyl)zirconiumAₙ; isopropylidene(cyclopentadienyl-indenyl)zirconiumAₙ; isopropylidene(cyclopentadienyl-2,7-di-t-butylfluorenyl)zirconiumAₙ; cyclohexylidene(cyclopentadienylfluorenyl)zirconiumAₙ; cyclohexylidene(cyclopentadienyl-2,7-di-t-butylfluorenyl)zirconiumAₙ; dimethylsilyl(cyclopentadienylfluorenyl)zirconiumAₙ; methylphenylsilyltetramethylcyclopentadienylcyclopropylamidotitaniumAₙ; methylphenylsilyltetramethylcyclopentadienylcyclobutylamidotitaniumAₙ; methylphenylsilyltetramethylcyclopentadienylcyclopentylamidotitaniumAₙ; methylphenylsilyltetramethylcyclopentadienylcyclohexylamidotitaniumAₙ; methylphenylsilyltetramethylcyclopentadienylcycloheptylamidotitaniumAₙ; methylphenylsilyltetramethylcyclopentadienylcyclooctylamidotitaniumAₙ; methylphenylsilyltetramethylcyclopentadienylcyclononylamidotitaniumAₙ; methylphenylsilyltetramethylcyclopentadienylcyclodecylamidotitaniumAₙ; methylphenylsilyltetramethylcyclopentadienylcycloundecylamidotitaniumAₙ; methylphenylsilyltetramethylcyclopentadienylcyclododecylamidotitaniumAₙ; methylphenylsilyl(tetramethylcyclopentadienyl)(sec-butylamido)titaniumAₙ; methylphenylsilyl(tetramethylcyclopentadienyl)(n-octylamido)titaniumAₙ; methylphenylsilyl(tetramethylcyclopentadienyl)(n-decylamido)titaniumAₙ; methylphenylsilyl(tetramethylcyclopentadienyl)(n-octadecylamido)titaniumAₙ; diphenylsilyltetramethylcyclopentadienylcyclopropylamidotitaniumAₙ; diphenylsilyltetramethylcyclopentadienylcyclobutylamidotitaniumAₙ; diphenylsilyltetramethylcyclopentadienylcyclopentylamidotitaniumAₙ; diphenylsilyltetramethylcyclopentadienylcyclohexylamidotitaniumAₙ; diphenylsilyltetramethylcyclopentadienylcycloheptylamidotitaniumAₙ; diphenylsilyltetramethylcyclopentadienylcyclooctylamidotitaniumAₙ; diphenylsilyltetramethylcyclopentadienylcyclononylamidotitaniumAₙ; diphenylsilyltetramethylcyclopentadienylcyclodecylamidotitaniumAₙ; diphenylsilyltetramethylcyclopentadienylcycloundecylamidotitaniumAₙ; diphenylsilyltetramethylcyclopentadienylcyclododecylamidotitaniumAₙ; diphenylsilyktetramethylcyclopentadienyl)(sec-butylamido)titaniumAₙ; diphenylsilyktetramethylcyclopentadienyl)(n-octylamido)titaniumAₙ; diphenylsilyktetramethylcyclopentadienyl)(n-decylamido)titaniumAₙ; and diphenylsilyktetramethylcyclopentadienyl)(n-octadecylamido)titaniumAₙ.

In one specific embodiment, the first catalyst component includes an isospecific metallocene catalyst (e.g., a catalyst capable of forming isotactic polypropylene (isotactic directing)), such as dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride, for example. In one specific embodiment, the first catalyst component comprises dimethylsilylbis(2-methyl-4-phenyl-indenyl)zirconium dichloride, for example.

In one embodiment, the first catalyst component includes a metallocene catalyst capable of producing a polymer having a high melting point (e.g., a Tₘ of from about 135° C. to about 165° C. or from about 140° C. to about 160° C. or from 145° C. to about 155° C.).

### Second Catalyst Component

In addition to the first catalyst component, the multicomponent catalyst compositions include a “second catalyst component”.

The second catalyst component generally includes a metallocene catalyst as described above. However, in one specific embodiment, the second catalyst component includes a syndiospecific metallocene catalyst (e.g., a catalyst capable of forming syndiotactic polypropylene (syndiotactic directing)), such as diphenylmethylene(1-cyclopentadienyl-1-fluorenyl)zirconium dichloride, diphenylmethylene (2,7-di-tert-butyl-fluorenyl)(cyclopentadienyl)zirconium dichloride, diphenylmethylene (3,6-di-tert-butyl-fluorenyl)(cyclopentadienyl)zirconium dichloride, dimethylmethylene(di-tert-butyl-fluorenyl)(cyclopentadienyl)zirconium dichloride, for example. In one specific embodiment, the second catalyst component comprises diphenylmethylene(1-cyclopentadienyl-1-fluorenyl)zirconium dichloride, for example.

The multicomponent catalyst system may have a ratio of first catalyst component to second catalyst component of from 1:1 or from 1:2 or from 2:1 or from 3:1. The molar ratio of the first catalyst component to the second catalyst component is from 1.0:0.376 to 1.0:2.26. Metallocene loading ranges from 1.0 to 2.5 wt % or from 1.5 to 2.0 wt %. The second catalyst component may be present in the multicomponent catalyst system in an amount as much as 70 wt % of the total catalyst system, or as much as 67 wt %.

### Activation

In certain embodiments, the methods described herein further include contacting one or more of the catalyst components with a catalyst activator, herein simply referred to as an “activator”. The activator may include a single composition capable of activating both the first catalyst component and the second catalyst component.

For example, the metallocene catalysts may be activated with a metallocene activator for subsequent polymerization. As used herein, the term “metallocene activator” is defined to be any compound or combination of compounds, supported or unsupported, which may activate a single-site catalyst compound (e.g., metallocenes, Group 15 containing catalysts, etc.) This may involve the abstraction of at least one leaving group (A group in the formulas/structures above, for example) from the metal center of the catalyst component. The metallocene catalysts are thus activated towards olefin polymerization using such activators.

Embodiments of such activators include Lewis acids, such as cyclic or oligomeric polyhydrocarbylaluminum oxides, non-coordinating ionic activators (“NCA”), ionizing activators, stoichiometric activators, combinations thereof or any other compound that may convert a neutral metallocene catalyst component to a metallocene cation that is active with respect to olefin polymerization.

The Lewis acids may include alumoxane (e.g., “MAO”), modified alumoxane (e.g., “TIBAO”) and alkylaluminum compounds, for example. Non-limiting examples of aluminum alkyl compounds may include trimethylaluminum, triethylaluminum, triisobutylaluminum, tri-n-hexylaluminum and tri-n-octylaluminum, for example.

Ionizing activators are well known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) CHEMICAL REVIEWS 1391-1434 (2000). Examples of neutral ionizing activators include Group 13 tri-substituted compounds, in particular, tri-substituted boron, tellurium, aluminum, gallium and indium compounds and mixtures thereof (e.g., tri(n-butyl)ammonium-tetrakis(pentafluorophenyl)borate and/or trisperfluorophenyl boron metalloid precursors), for example. The substituent groups may be independently selected from alkyls, alkenyls, halogen, substituted alkyls, aryls, arylhalides, alkoxy and halides, for example. In one embodiment, the three groups are independently selected from halogens, mono or multicyclic (including halosubstituted) aryls, alkyls, alkenyl compounds and mixtures thereof, for example. In another embodiment, the three groups are selected from C₁ to C₂₀ alkenyls, C₁ to C₂₀ alkyls, C₁ to C₂₀ alkoxys, C₃ to C₂₀ aryls and combinations thereof, for example. In yet another embodiment, the three groups are selected from the group highly halogenated C₁ to C₄ alkyls, highly halogenated phenyls, and highly halogenated naphthyls and mixtures thereof, for example. By “highly halogenated”, it is meant that at least 50% of the hydrogens are replaced by a halogen group selected from fluorine, chlorine and bromine.

Illustrative, not limiting examples of ionic ionizing activators include trialkyl-substituted ammonium salts (e.g., triethylammoniumtetraphenylborate, tripropylammoniumtetraphenylborate, tri(n-butyl)ammoniumtetraphenylborate, trimethylammoniumtetra(p-tolyl)borate, trimethylammoniumtetra(o-tolyl)borate, tributylammoniumtetra(pentafluorophenyl)borate, tripropylammoniumtetra(o,p-dimethylphenyl)borate, tributylammoniumtetra(m,m-dimethylphenyl)borate, tributylammoniumtetra(p-tri-fluoromethylphenyl)borate, tributylammoniumtetra(pentafluorophenyl)borate and tri(n-butyl)ammoniumtetra(o-tolyl)borate), N,N-dialkylanilinium salts (e.g., N,N-dimethylaniliniumtetraphenylborate, N,N-diethylaniliniumtetraphenylborate and N,N-2,4,6-pentamethylaniliniumtetraphenylborate), dialkyl ammonium salts (e.g., diisopropylammoniumtetrapentafluorophenylborate and dicyclohexylammoniumtetraphenylborate), triaryl phosphonium salts (e.g., triphenylphosphoniumtetraphenylborate, trimethylphenylphosphoniumtetraphenylborate and tridimethylphenylphosphoniumtetraphenylborate) and their aluminum equivalents, for example.

In yet another embodiment, an alkylaluminum compound may be used in conjunction with a heterocyclic compound. The ring of the heterocyclic compound may include at least one nitrogen, oxygen, and/or sulfur atom, and includes at least one nitrogen atom in one embodiment. The heterocyclic compound includes 4 or more ring members in one embodiment, and 5 or more ring members in another embodiment, for example.

The heterocyclic compound for use as an activator with an alkylaluminum compound may be unsubstituted or substituted with one or a combination of substituent groups. Examples of suitable substituents include halogens, alkyls, alkenyls or alkynyl radicals, cycloalkyl radicals, aryl radicals, aryl substituted alkyl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals or any combination thereof, for example.

Non-limiting examples of hydrocarbon substituents include methyl, ethyl, propyl, butyl, pentyl, hexyl, cyclopentyl, cyclohexyl, benzyl, phenyl, fluoromethyl, fluoroethyl, difluoroethyl, iodopropyl, bromohexyl or chlorobenzyl, for example.

Non-limiting examples of heterocyclic compounds utilized include substituted and unsubstituted pyrroles, imidazoles, pyrazoles, pyrrolines, pyrrolidines, purines, carbazoles, indoles, phenyl indoles, 2,5-dimethylpyrroles, 3-pentafluorophenylpyrrole, 4,5,6,7-tetrafluoroindole or 3,4-difluoropyrroles, for example.

Combinations of activators are also contemplated by the invention, for example, alumoxanes and ionizing activators in combinations. Other activators include aluminum/boron complexes, perchlorates, periodates and iodates including their hydrates, lithium (2,2′-bisphenyl-ditrimethylsilicate)-4T-HF and silylium salts in combination with a non-coordinating compatible anion, for example. In addition to the compounds listed above, methods of activation, such as using radiation and electro-chemical oxidation are also contemplated as activating methods for the purposes of enhancing the activity and/or productivity of a single-site catalyst compound, for example. (See, U.S. Pat. No. 5,849,852, U.S. Pat. No. 5,859,653, U.S. Pat. No. 5,869,723 and WO 98/32775.)

The catalyst may be activated in any manner known to one skilled in the art. For example, the catalyst and activator may be combined in molar ratios of activator to catalyst of from 1000:1 to 0.1:1, or from 500:1 to 1:1, or from about 100:1 to about 250:1, or from 150:1 to 1:1, or from 50:1 to 1:1, or from 10:1 to 0.5:1 or from 3:1 to 0.3:1, for example.

### Support

The activators may or may not be associated with or bound to a support, either in association with one or more catalyst component or separate from the catalyst component(s), such as described by Gregory G. Hlalky, Heterogeneous Single-Site Catalysts for Olefin Polymerization 100(4) CHEMICAL REVIEWS 1347-1374 (2000).

For example, each different catalyst component may reside on a single support particle, so that the multicomponent catalyst is a supported multicomponent catalyst. However, as used herein, the term multicomponent catalyst also broadly includes a system or mixture in which one of the catalysts (e.g., the first catalyst component) resides on one collection of support particles and another catalyst (e.g., the second catalyst component) resides on another collection of support particles. In the latter instance, the two supported catalysts are introduced to a single reactor, either simultaneously or sequentially and polymerization is conducted in the presence of the multicomponent catalyst. In certain embodiments, an unsupported version of the multicomponent catalyst described herein can be used in a polymerization process, i.e., in which the monomers are contacted with a multicomponent catalyst that is not supported.

The support materials may include talc, inorganic oxides, clays and clay minerals, ion-exchanged layered compounds, diatomaceous earth compounds, zeolites or a resinous support material, such as a polyolefin, for example. Specific examples of silica supports include P10 (available from Fuji-Silysia) and H121c (available from Austin Chemical Company, Inc.). In a further embodiment, the silica is modified with MAO (methylaluminoxane).

Specific inorganic oxides include silica, alumina, magnesia, titania and zirconia, for example. The inorganic oxides used as support materials may have an average particle size of from 5 microns to 600 microns or from 10 microns to 100 microns, a surface area of from 50 m²/g to 1,000 m²/g or from 100 m²/g to 400 m²/g and a pore volume of from 0.5 cc/g to 3.5 cc/g or from 0.5 cc/g to 2 cc/g, for example.

Methods for supporting metallocene catalysts are generally known in the art. (See, U.S. Pat. No. 5,643,847, U.S. patent Ser. Nos. 09/184,358 and 09/184,389, which are incorporated by reference herein.)

Various methods can be used to affix two different metallocene components to a support to form a multicomponent catalyst (also referred to as a “mixed catalyst”). For example, one procedure for preparing a supported multicomponent catalyst can include providing a supported first catalyst component, contacting a slurry including the first catalyst component and a non-polar hydrocarbon with a mixture (solution or slurry) that includes the second catalyst component, which may also include an activator. The procedure may further include drying the resulting product that includes the first and second catalyst components and recovering a multicomponent catalyst composition. Another method may include reacting the silica (such as P10 or H121c) with MAO in a hydrocarbon solvent and heat to form an MAO-modified silica. Subsequent steps then include adding the first catalyst component to the MAO-modified silica, then adding the second catalyst component to form a multicomponent catalyst on a single support. Another method may include mixing the first catalyst component and the second catalyst component in a solvent then adding the MAO-modified silica. Another method may include supporting the first catalyst component on a first MAO-modified silica and supporting the second catalyst component on a second MAO-modified silica and physically mixing the supported catalysts. Alternatively, it is contemplated that the first and second catalyst components may be independently fed to one or more reaction zones, so long as each reaction zone includes a multicomponent system as described herein.

Resin reactor blending can be achieved by either separate supported catalysts mixing inside the catalyst pot before being injected into the loop reactor (Metallocene Catalyst Mixing) or metallocene deposition on the same support during the supported catalyst preparation (Metallocene Catalyst Co-Supporting).

Optionally, the support material, one or more of the catalyst components, the catalyst system or combinations thereof, may be contacted with one or more scavenging compounds prior to or during polymerization. The term “scavenging compounds” is meant to include those compounds effective for removing impurities (e.g., polar impurities) from the subsequent polymerization reaction environment. Impurities may be inadvertently introduced with any of the polymerization reaction components, particularly with solvent, monomer and catalyst feed, and adversely affect catalyst activity and stability. Such impurities may result in decreasing, or even elimination, of catalytic activity, for example. The polar impurities or catalyst poisons may include water, oxygen and metal impurities, for example.

The scavenging compound may include an excess of the aluminum containing compounds described above, or may be additional known organometallic compounds, such as Group 13 organometallic compounds. For example, the scavenging compounds may include trimethyl aluminum (TMA), triisobutyl aluminum (TIBA1), methylalumoxane (MAO), isobutyl aluminoxane, triethylaluminum (TEA1), and tri-n-octyl aluminum. In one specific embodiment, the scavenging compound is TIBA1.

In one embodiment, the amount of scavenging compound is minimized during polymerization to that amount effective to enhance activity and avoided altogether if the feeds and polymerization medium may be sufficiently free of impurities.

### Polymerization Processes

Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. Other monomers include ethylenically unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

Further, a two-staged sequential polymerization process wherein a miPP/sPP/EPR (ethylene-propylene rubber) reactor blend can be obtained.

### Catalyst Activity

In one embodiment, the multicomponent catalyst has an activity of from 5 kg/g/hr to 25 kg/g/hr, or from 7 kg/g/hr to 17 kg/g/hr, or from 9 kg/g/hr to 15 kg/g/hr, or from 11 kg/g/hr to 13 kg/g/hr.

In one embodiment, the multicomponent catalyst has a conversion of propylene of from 15 to 60%, or from 20 to 50%, or from 25 to 45%.

### Polymer Product

The polymers (and blends thereof) formed via the processes described herein may include, but are not limited to, polypropylene (e.g., syndiotactic, atactic and isotactic) and polypropylene copolymers, for example.

The polymers can have a variety of compositions, characteristics and properties. At least one of the advantages of the multicomponent catalysts is that the process utilized can be tailored to form a polymer composition having a desired set of properties. A non-limiting discussion of such properties follows.

In one embodiment, the polymers include propylene polymers. In one embodiment, the propylene polymer includes isotactic polypropylene and syndiotactic polypropylene. In one embodiment, the propylene polymer comprises from 5 to 30 wt % syndiotactic polypropylene, or from 10 to 25 wt % syndiotactic polypropylene, or from 15 to 20 wt % syndiotactic polypropylene. In one embodiment, the propylene polymer comprises from 5 to 30 wt % isotactic polypropylene, or from 10 to 25 wt % isotactic polypropylene, or from 15 to 20 wt % isotactic polypropylene.

The propylene polymers may include propylene homopolymers or copolymers. Unless otherwise specified, the terms “propylene polymer” or “polypropylene” may refer to propylene homopolymers or those polymers composed primarily of propylene and limited amounts of other comonomers, such as ethylene, wherein the comonomer makes up less than 0.5 wt. % or less than about 0.1 wt. % by weight of polymer, or to propylene copolymers composed primarily of propylene and a comonomer, such as ethylene, wherein the comonomer makes up from 1 wt % to 20 wt %, or from 5 wt % to 15 wt % of the polymer.

The propylene polymer may include not only miPP and sPP, but also ethylene-propylene rubber (EPR). Such a composition would be formed via a two-staged sequential polymerization process, well known to those of ordinary skill in the art.

In one embodiment, the propylene polymer exhibits a melt flow rate of from 1 to greater than 200 g/10 min., or from 10 to 150 g/10 min., or from 20 to 100 g/10 min., or from 30 to 80 g/10 min., or from 40 to 65 g/10 min. The melt flow rate may also be from 1 to 10 g/10 min. or from 2 g/10 min. to 5 g/10 min.

In one embodiment, the propylene polymer exhibits a melting point of from 120 to 160° C., or from 150 to 155° C., or from 140 to 145° C. In one embodiment, the propylene polymer, comprising both isotactic and syndiotactic polypropylene, may exhibit at least two melting points, for example, the polymer may exhibit a first melting point of 130° C. and a second melting point of 145° C.

In one embodiment, the propylene polymer exhibits a xylene solubles level from 0.20 to 10.00 wt %, or from 0.25 to 1.20 wt %, or from 0.35 to 0.80 wt %, or from 0.40 to 0.65 wt %, or from 0.45 to 0.60 wt %.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example. Molded articles include single and multi-layered constructions in the form of bottles, tanks, large hollow articles, rigid food containers and toys, for example.

In one specific embodiment, the polymers are useful for woven and nonwoven applications, including fibers formed by melt spinning, solution spinning and melt blowing.

### Examples

As used in the examples, metallocene type “m” refers to rac-dimethylsilanylbis(2-methyl-4-phenyl-1-indenyl)zirconium dichloride.

As used in the examples, metallocene type “MC6” refers to diphenylmethylene(1-cyclopentadienyl-1-fluorenyl)zirconium dichloride.

Unless otherwise designated herein, all testing methods are the current methods at the time of filing.

The two catalysts, m and MC6, were deposited on the MAO-modified silica carrier P10 (P10/MAO (1.0/0.7 in wt)) and H121c (H121c/MAO (1.0/0.85 in wt)). P10 offered much better fluff morphology control under all ‘m’:MC6 ratios, as can be seen in Table 2, although H121c gave higher polymerization activity as can be seen in Table 3.

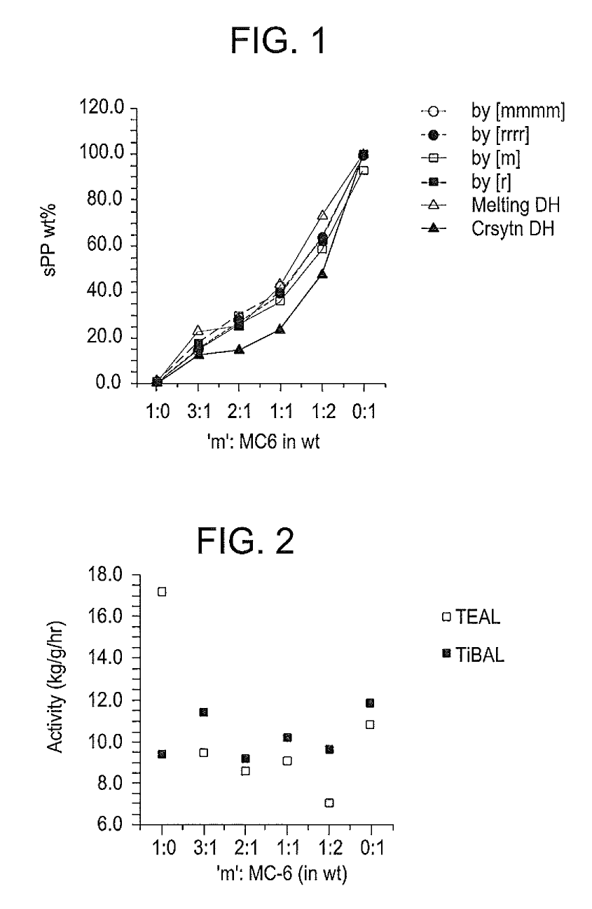

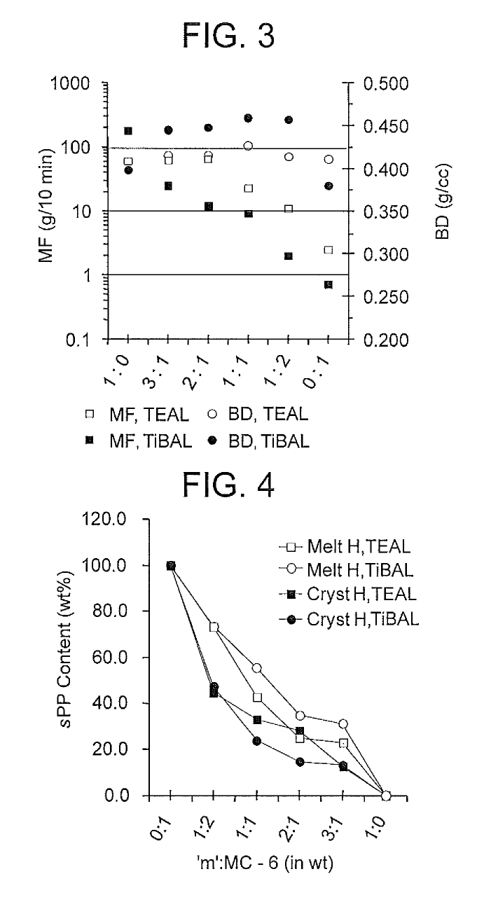

¹³C NMR composition analysis showed that the mixed catalyst ‘m’:MC6 at a ratio of 3:1 produced the desired reactor blends with sPP content less than 20 wt % (FIG. 1). Total metallocene loading is optimized at 2.0 wt % with ‘m’:MC6 at a ratio of 3:1 in weight. TiBAL showed better scavenger effect than TEAL from the viewpoint of catalyst activity and fluff bulk density (FIG. 2 and FIG. 3). Without being limited to any one particular theory, it is believed that higher sPP content in the reactor blend with TiBAL as scavenger (as shown by DSC, FIG. 4) originated from the activity increase of MC6 over ‘m’ by the alkylaluminum.

The MWD broadening of miPP/sPP reactor blends increases as MC6 content rises. Without being limited to any one particular theory, because of the difference in hydrogen response of each component, the mixed catalyst ‘m’ and MC6 will also offer different MWD resins with different melt flow rate and sPP content.

A total of twenty supported metallocene catalysts were synthesized with MAO-modified P10 and H121c as supports and tested under standard bench polymerization conditions. The weight ratio of the mixed ‘m’:MC-6 ranged from 3.0:1.0 to 1.0:2.0, with the molar ratio from 1.0:0.376 to 1.0:2.26. The metallocene loading varied from 1.0 to 2.5 wt %, with the most at 2.0 wt %. P10-supported mixed catalysts provided lower propylene polymerization activity (7.0-10.0 kg/g/hr) than H121c (10.0-12.0 kg/g/hr), but much higher fluff bulk density (0.400-0.430 g/cc vs. 0.260-0.330 g/cc). The melt flow varied from 2 to 100 g/10 min with different metallocene mix ratios under the same hydrogen concentration.

For catalysts with MAO/P10 as the support carrier and ‘m’:MC-6 weight ratio 1:1, the propylene polymerization activity increased from 6.3 to 9.6 kg/g/hr as the total metallocene loading changed from 1.0 to 2.0 wt % (See, Table 1). The activity stayed almost the same as the metallocene loading further rose to 2.5 wt %. The fluff bulk density stayed in the range of 0.420 to 0.430 g/cc. The melt flow decreased from 39 to 22 g/10 min as the metallocene loading increased from 1.0 to 2.5 wt %. Two percent metallocene weight loading was selected for the supported catalysts with different metallocene mixing weight ratios.

TABLE 1
Propylene Polymerization with MC6 and ‘m’ Metallocene Mixed Catalysts on
the Same MAO-Modified P10-Supported Carrier with Different Metallocene Loadings ^{a)}

| | Met | | | | | | Avg. |
|---|---|---|---|---|---|---|---|
| | Loadings | Polymer | C₃⁼ Convn | Activity | BD | MF | Fouling |
| Example | (in wt) | Yield (g) | (%) | (kg/g/hr) | (g/cc) | (g/10 min) | (mg/g) |
| 1 | 1.0 | 127 | 17 | 6.3 | 0.426 | 39 | 2 |
| 2 | 1.5 | 158 | 22 | 7.9⁵ | 0.419 | 39 | 2 |
| 3 | 2.0 | 193 | 26 | 9.5 | 0.428 | 25 | 2 |
| 4 | 2.5 | 187 | 25 | 9.1 | 0.426 | 22 | 2 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified P10 silica carrier. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The ‘m’:MC-6 weight ratio is 1.0:1.0.

The ‘m’:MC-6 weight ratio varied from 3:1 to 1:2, along with the two supported ‘m’ and MC-6 catalysts. Both MAO/P10 and MAO/H121c were used as the support carriers. The propylene polymerization results (See Table 2 and Table 3) with TEAL as the scavenger showed that MAO/H121c offered higher polymerization activity for all the metallocene mixing catalysts (11.2 kg/g/hr). For P10-supported catalysts, the activities for the multicomponent catalysts were in the range of 7.0-10.0 kg/g/hr, which were lower than that of both ‘m’ and MC-6 catalysts with activities of 17.2 and 10.9 kg/g/hr, respectively. For H121c, however, little difference in propylene polymerization activity could be seen between the multicomponent catalysts and the single metallocene catalysts, which were in the range of 10.0 to 12.0 kg/g/hr, although MAO/P10 provided much higher polymerization activity to ‘m’ (17.2 vs 10.8 kg/g/hr) and slightly lower activity to MC-6 catalyst (10.9 vs. 11.2 kg/g/hr).

TABLE 2
Propylene Polymerization with MC6 and ‘m’ Metallocene Mixed Catalysts on
the Same MAO-Modified P10-Supported Carrier with Different Metallocene Ratios ^{a, b)}

| | | | | | | | Avg. |
|---|---|---|---|---|---|---|---|
| | ‘m’:MC-6 | Polymer | C₃⁼ Convn | Activity | BD | MF | Fouling |
| Example | (in wt) | Yield (g) | (%) | (kg/g/hr) | (g/cc) | (g/10 min) | (mg/g) |
| 5 | 1:0 | 342 | 46 | 17.2 | 0.398 | 60 | — |
| 6 | 3:1 | 191 | 26 | 9.5 | 0.415 | 62 | — |
| 7 | 2:1 | 173 | 23 | 8.6 | 0.415 | 65 | — |
| 8 | 1:1 | 185 | 25 | 9.1 | 0.427 | 23 | — |
| 9 | 1:2 | 142 | 20 | 7.1 | 0.414 | 11 | 2 |
| 10 | 0:1 | 220 | 30 | 10.9 | 0.411 | 2.5 | 1 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified P10 silica carrier. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The total metallocene loadings are 2.0 wt %.

TABLE 3
Propylene Polymerization with MC6 and ‘m’ Metallocene
Mixed Catalysts on the Same MAO-Modified H121c-Supported Carrier with
Different Metallocene Ratios ^{a,} ^{b)}

| | | | | | | | Avg. |
|---|---|---|---|---|---|---|---|
| | ‘m’:MC-6 | Polymer | C₃⁼ | Activity | BD | MF | Fouling |
| Example | (in wt) | Yield (g) | Convn (%) | (kg/g/hr) | (g/cc) | (g/10 min) | (mg/g) |
| 11 | 1:0 | 220 | 29 | 10.8 | 0.261 | 111 | 5 |
| 12 | 3:1 | 222 | 30 | 10.9 | 0.261 | 100 | 4 |
| 13 | 2:1 | 194 | 27 | 11.8 | 0.311 | 77 | 3 |
| 14 | 1:1 | 242 | 33 | 9.8 | 0.279 | 38 | 3 |
| 15 | 1:2 | 211 | 28 | 10.5 | 0.328 | 23 | 2 |
| 16 | 0:1 | 222 | 30 | 11.2 | 0.270 | 2.1 | 3 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified H121c silica carrier with formulation of 0.85/1.0 in weight. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The total metallocene loadings are 2.0 wt %.

P10-supported catalysts offered much higher fluff bulk density (0.400-0.430 g/cc) than those by H121c (0.260-0.330 g/cc) (See Tables 2 and 3). Moreover, the bulk density of fluff from P10-based catalysts increased as the metallocene ‘m’ was being partially or fully replaced by MC6. The fluff melt flows decreased as the content of MC6 increased, no matter what the support. MC6 catalysts offered much lower polymer melt flow than that of ‘m’ under the same testing conditions, no matter what the support. For MC6, the fluff melt flows from both P10 and H121c supports were almost the same at 2 g/10 min. For ‘m’, however, much higher melt flow was observed for H121c (111 g/10 min) than for P10 (60 g/10 min). Moreover, the melt flows of fluffs from H121c-catalyst were always higher than that of the P10-catalysts with the same starting metallocene mixing composition and loading. Correlated with the different activity between P10- and H121c-supported catalysts, this observation implies that more ‘m’ was likely to be activated by MAO/P10, but there was no activation preference to MC6. Without being limited to any one theory, it is believed that the concentration of active centers on MAO/P10 and MAO/H121c supports was different even though the starting ‘m’ and MC6 mixing ratios and total metallocene deposition amount were the same. Furthermore, the active center ratio of ‘m’ and MC6 could not be the same as the starting mixing composition. MAO/P10 would contain more ‘m’ than MAO/H121c. Changing the metallocene loading may also affect the ratio of the two active centers.

This has been reflected by the dramatic change of fluff melt flow in P10-supported catalysts (See Table 1). Table 4 provides the propylene polymerization results of H121c-supported catalysts with different metallocene loadings from 1.0 to 2.5 wt % under the same ‘m’:MC-6 weight ratio of 3.0:1.0. The polymerization activity reached peak at about 1.5 wt % instead of 2.0 wt % as for P10-supported catalyst with a 1.0:1.0 ‘m’:MC-6 mixing ratio. Low activity catalyst provided high melt flow polymer fluffs. Low bulk density has resulted for all the H121c-supported catalysts.

TABLE 4
Propylene Polymerization with MC6 and ‘m’ Metallocene
Mixed Catalysts on the Same MAO-Modified H121c-Supported Carrier
with Different Metallocene Loadings ^{a)}

| | Met | | | | | | Avg. |
|---|---|---|---|---|---|---|---|
| | Loadings | Polymer | C₃⁼ Convn | Activity | BD | MF | Fouling |
| Example | (in wt) | Yield (g) | (%) | (kg/g/hr) | (g/cc) | (g/10 min) | (mg/g) |
| 17 | 1.0 | 108 | 15 | 5.3⁵ | 0.274 | >200 | 3 |
| 18 | 1.5 | 163 | 22 | 13.3 | 0.266 | 33 | 3 |
| 19 | 2.0 | 216 | 30 | 10.0 | 0.262 | 48 | 4 |
| 20 | 2.5 | 269 | 36 | 8.1 | 0.285 | 140 | 3 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified H121c silica carrier with formulation of 0.85/1.0 in weight. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The ‘m’:MC-6 weight ratio is 3.0:1.0.

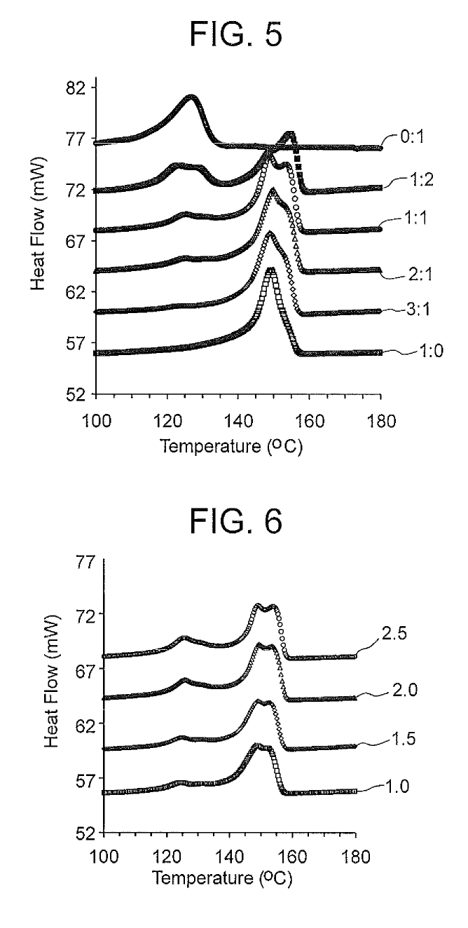

For catalysts with MAO/P10 as the support carrier and metallocene loading amount of 2.0 wt %, the polymer characterization results are given in Table 5 and FIG. 5. The xylene solubles stayed low for the blends. MC6 offered much higher molecular weight than ‘m’ alone (Example 10 vs 5, Table 5). But the multicomponent catalyst provided resins with as low molecular weight as ‘m’, even though the weight content of MC6 reached as high as 67 wt %. The molecular weight distribution was broadened as the content of MC6 increased. Two melting points occurred for most multicomponent catalysts, with one in the range of 150° C. corresponding to ‘m’ and the other 125° C. from MC6. From the DSC profiles, FIG. 5, it can be qualitatively shown that the sPP content increased as MC-6 weight content rose. The high melting thermographs of the blends were broadened or even split (FIG. 5), indicating the presence of sPP changed the crystallization behavior of miPP.

TABLE 5
Physical Characterization of Reactor Blends from MC6 and ‘m’ Metallocene Mixed Catalysts
on the Same MAO-Modified P10-Supported Carrier with Different Metallocene Ratios ^{a, b)}

| | ‘m’:MC-6 | Polymer | Activity | Melting Point (° C.) | | Mn | PDI | Xsol |
|---|---|---|---|---|---|---|---|---|
| Example | (in wt) | Yield (g) | (kg/g/hr) | 1^{st} | 2^{nd} | (10⁻³) | (Mn/Mw) | (wt %) |
| 5 | 1:0 | 342 | 17.2 | 149.4 | — | 33.7 | — | 0.60 |
| 6 | 3:1 | 191 | 9.5 | 149.0 | — | 33.5 | 3.9 | 0.64 |
| 7 | 2:1 | 173 | 8.6 | 150.0 | 125.2 | 25.0 | 4.9 | 0.48 |
| 8 | 1:1 | 185 | 9.1 | 149.0 | 124.0 ^{c)} | 34.3 | 4.3 | 0.40 |
| 9 | 1:2 | 142 | 7.1 | 154.7 | 123.3 | 32.6 | 4.6 | 0.48 |
| 10 | 0:1 | 220 | 10.9 | 128.7 | — | 78.7 | 2.5 | 0.52 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified P10 silica carrier. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The total metallocene loadings are 2.0 wt %.
^{c)} The third melting peak is 153.5° C.

Changing the metallocene loading from 1.0 to 2.5 wt % had little effect on the molecular weight distribution, although the molecular weight increased from 30.7 to 35.6 K (Table 6). Without being limited to any one theory, it is believed that this phenomenon was more likely related to the bench polymerization testing, where initial hydrogen concentration was the same but the number of the supported active centers was increasing. Three instead of two melting points are identified for all the resins, resulting from the split of the miPP corresponding melting peak (FIG. 6). Low xylene solubles were as expected for the reactor blends.

TABLE 6
Physical Characterization of Reactor Blends from MC6 and ‘m’ Metallocene Mixed Catalysts
on the Same MAO-Modified P10-Supported Carrier with Different Metallocene Loadings ^{a)}

| | Met | | | | | | | | |
|---|---|---|---|---|---|---|---|---|---|
| | Loadings | Polymer | Activity | Melting Point (° C.) | | | Mn | PDI | Xsol |
| Example | (in wt) | Yield (g) | (kg/g/hr) | 1^{st} | 2^{nd} | 3^{rd} | (10⁻³) | (Mn/Mw) | (wt %) |
| 1 | 1.0 | 127 | 6.3 | 149.0 | 124.5 | 152.2 | 30.7 | 4.2 | 0.48 |
| 2 | 1.5 | 158 | 7.9⁵ | 149.0 | 125.0 | 152.6 | 30.8 | 4.1 | 0.48 |
| 3 | 2.0 | 193 | 9.5 | 149.4 | 125.9 | 153.7 | 34.3 | 4.5 | 0.36 |
| 4 | 2.5 | 187 | 9.1 | 149.0 | 125.7 | 153.8 | 35.6 | 4.0 | 0.28 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified P10 silica carrier. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The ‘m’:MC-6 weight ratio is 1.0:1.0.

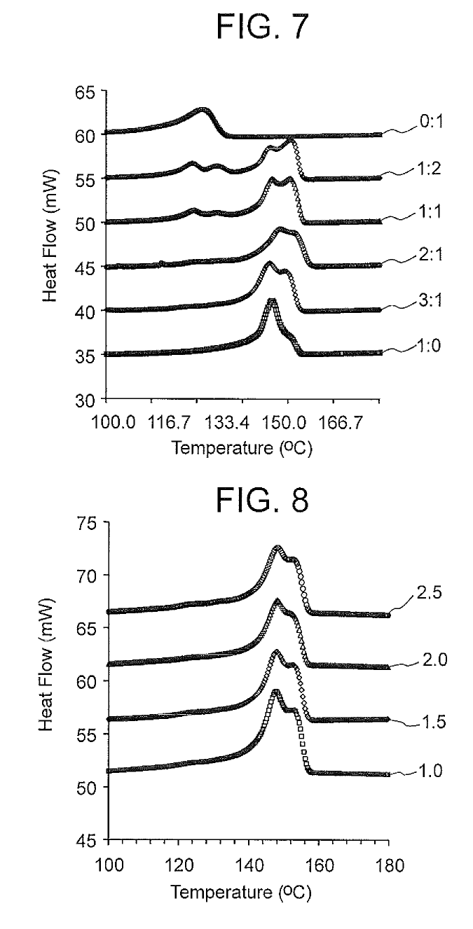

For MAO/H121 supported ‘m’/MC6 catalysts with total metallocene loading amount of 2.0 wt %, Table 7 and FIG. 7 provide the polymer characterization results. MC6 again offered much higher molecular weight than ‘m’ alone (Example 16 vs 11, Table 7). However, the multicomponent catalysts provided resins with as low molecular weight as ‘m’, even though the weight content of MC6 reached as high as 67 wt %. The molecular weight distribution was broadened. The xylene solubles stayed relatively low for all the blends. Three melting points occurred for some reactor blends, with two in the range of 150° C. corresponding to ‘m’ and the other 125° C. from MC6. DSC profiles (FIG. 7) qualitatively show that the sPP content increased as MC6 weight content rose. Some of the low melting thermographs were split, indicating the interaction effect on crystallization of sPP and miPP.

TABLE 7
Physical Characterization of Polymers from MC6 and ‘m’ Metallocene Mixed Catalysts
on the Same MAO-Modified H121c-Supported Carrier with Different Metallocene Ratios ^{a, b)}

| | Notebook | ‘m’:MC-6 | Polymer | Activity | Melting Point (° C.) | | | Mn | PDI | Xsol |
|---|---|---|---|---|---|---|---|---|---|---|
| Entry | No. | (in wt) | Yield (g) | (kg/g/hr) | 1^{st} | 2^{nd} | 3^{rd} | (10⁻³) | (Mn/Mw) | (wt %) |
| 1 | 1064-080 | 1:0 | 220 | 10.8 | 148.4 | — | — | 22.3 | — | 0.88 |
| 2 | 1064-078 | 3:1 | 222 | 10.9 | 147.7 | 152.7 | — | 24.1 | 4.7 | 0.48 |
| 3 | 1064-077 | 2:1 | 194 | 11.8 | 151.0 | — | — | 26.2 | 4.4 | 0.56 |
| 4 | 1064-076 | 1:1 | 242 | 9.8 | 153.7 | 148.5 | 125.7 | 31.6 | 4.1 | 0.48 |
| 5 | 1064-079 | 1:2 | 211 | 10.5 | 154.0 | 148.0 | 125.6 | 36.6 | 3.7 | 0.20 |
| 6 | 1064-081 | 0:1 | 222 | 11.2 | 128.0 | — | — | 91.2 | 2.1 | 0.56 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified H121c silica carrier with formulation of 0.85/1.0 in weight. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The total metallocene loadings are 2.0 wt %.

Metallocene loading from 1.0 to 2.5 wt %, again had little effect on the resin molecular weight distribution, although the molecular weight changed from 18.9 to 31.0 K (Table 8) due to the same reason as explained for P10-supported catalysts. For 3:1 ‘m’: MC-6 metallocene weight ratio, hardly any sPP can be distinguished from the DSC profiles (FIG. 8) at the range of 125° C. But the melting peak split of miPP does tell the existence of sPP. All the DSC profiles were almost the same in spite of the different metallocene loadings. Low xylene solubles were as expected for the reactor blends, except the 2.5 wt % loading has a xylene solubles of 1.12 wt %.

TABLE 8
Physical Characterization of Polymers from MC6 and ‘m’ Metallocene Mixed Catalysts
on the Same MAO-Modified H121c-Supported Carrier with Different Metallocene Loadings ^{a)}

| | Met | | | | | | | |
|---|---|---|---|---|---|---|---|---|
| | Loadings | Polymer | Activity | Melting Point (° C.) | | Mn | PDI | Xsol |
| Example | (in wt) | Yield (g) | (kg/g/hr) | 1^{st} | 2^{nd} | (10⁻³) | (Mn/Mw) | (wt %) |
| 17 | 1.0 | 108 | 5.35 | 147.7 | 153.1 | 18.9 | 4.6 | 0.76 |
| 18 | 1.5 | 163 | 13.3 | 148.0 | 153.2 | 23.0 | 4.4 | 0.44 |
| 19 | 2.0 | 216 | 10.0 | 148.0 | — | 28.8 | 5.4 | 0.40 |
| 20 | 2.5 | 269 | 8.1 | 148.0 | — | 31.0 | 5.0 | 1.12 |

^{a)} MC6 (diphenylmethylene(cylopentadienyl)(1-fluorenyl)zirconium dichloride) and ‘m’ (rac-dimethylsilylanediylbis (2-methyl-4-phenyl-1-indenyl)zirconium dichloride) metallocenes were mixed in toluene and then deposited/cationized on the MAO-modified H121c silica carrier with formulation of 0.85/1.0 in weight. Polymerization conditions: 20 mg supported catalyst, ca. 720 g propylene, 60 mg TEAL as scavenger in 2 L Autoclave Zipper reactor with initial hydrogen concentration 70 ppm, 60° C. for 1 hour.
^{b)} The ‘m’:MC-6 weight ratio is 3.0:1.0.

Table 5 and 6 show the number average molecular weight comparison of the reactor blends from the mixed catalysts with the same metallocene loading (2.0 wt %) and ‘m’:MC6 weight ratio but different silica support. Both gave a similar trend, with an increase of MC6 weight amount slightly raising the molecular weight, but far lower than sPP alone. P10-supported catalysts tended to offer higher molecular weight blends when ‘m’ dominated the content, while H121-based catalysts showed more reliable MW trends.

As for the metallocene loading effect on the molecular weight, P10-based catalysts with ‘m’ to MC-6 at a ratio of 1:1 offered a much milder increasing fashion than H121 catalysts with ‘m’/MC-6 at a ratio of 3:1 in weight (See Tables 6 and 8).

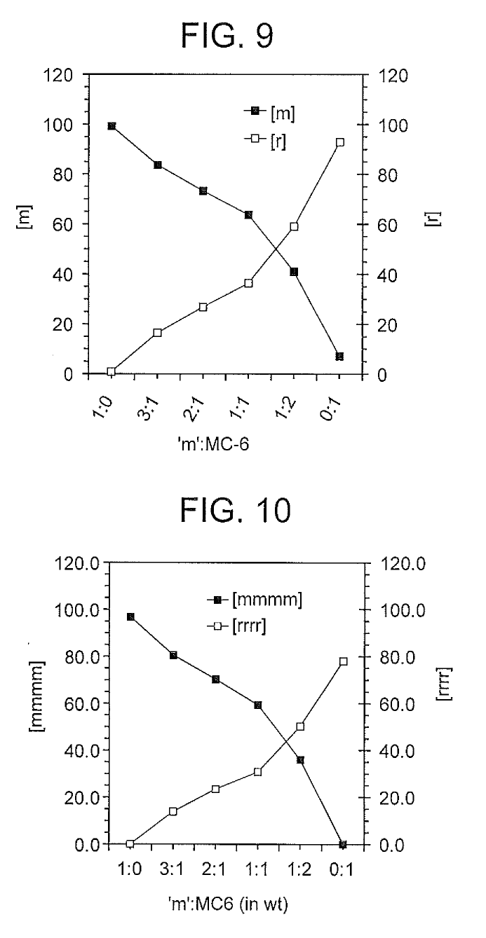

For catalysts with MAO/P10 as the support carrier and metallocene loading amount 2.0 wt %, the ¹³C NMR racemic and meso dyads and pentads microstructure characterization results are provided in FIGS. 9 and 10. The sPP content calculated from the isotacticity is shown in FIG. 1. As expected, the sPP content increased much faster as the weight content of MC6 was over 50%.

While various embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A polymerization process comprising:
providing a multicomponent catalyst system comprising:
a first catalyst component comprising a metallocene catalyst represented by the general formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4; and
a second catalyst component generally represented by the formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4;
introducing the multicomponent catalyst system to a reaction zone;
introducing propylene monomer to the reaction zone;
contacting the multicomponent catalyst system with the propylene monomer; and
withdrawing the polymer from the reaction zone.

2. The process of claim 1, wherein the first catalyst component comprises an isotactic directing metallocene catalyst.

3. The process of claim 1, wherein the second catalyst component comprises a syndiotactic directing metallocene catalyst.

4. The process of claim 2, wherein the first catalyst component is selected from dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride, and combinations thereof.

5. The process of claim 3, wherein the second catalyst component is selected from diphenylmethylene(1-cyclopentadienyl-1-fluorenyl)zirconium dichloride, diphenylmethylene (2,7-di-tert-butyl-fluorenyl)(cyclopentadienyl)zirconium dichloride, diphenylmethylene (3,6-di-tert-butyl-fluorenyl)(cyclopentadienyl)zirconium dichloride, and combinations thereof.

6. The process of claim 3, wherein the second catalyst component comprises less than 70 wt % of the multicomponent catalyst.

7. The process of claim 1, wherein the activity is greater than 7 kg/g/hr.

8. The process of claim 1, wherein the polymer comprises between 5 and 20 wt % syndiotactic polypropylene.

9. A bicomponent catalyst system comprising:
a first catalyst component comprising a metallocene catalyst represented by the general formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4; and
a second catalyst component generally represented by the formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4.

10. The catalyst system of claim 9, wherein the first catalyst component comprises an isotactic directing metallocene catalyst.

11. The catalyst system of claim 9, wherein the first catalyst component comprises a metallocene catalyst capable of producing a polymer comprising a melting point of from about 135° C. to about 165° C.

12. The catalyst system of claim 9, wherein the second catalyst component comprises a syndiotactic directing metallocene catalyst.

13. The catalyst system of claim 9, wherein the second catalyst component is selected from diphenylmethylene(1-cyclopentadienyl-1-fluorenyl)zirconium dichloride, diphenylmethylene (2,7-di-tert-butyl-fluorenyl)(cyclopentadienyl)zirconium dichloride, diphenylmethylene (3,6-di-tert-butyl-fluorenyl)(cyclopentadienyl)zirconium dichloride and combinations thereof.

14. The catalyst system of claim 9, wherein the first catalyst component is selected from dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride and combinations thereof.

15. The catalyst system of claim 9, further comprising a support material.

16. The catalyst system of claim 15, wherein the first catalyst component and second catalyst component are supported on the same support material.

17. The catalyst system of claim 15, wherein the first catalyst component is supported on a first support material and the second catalyst component is supported on a second support material.

18. The catalyst system of claim 15, wherein the support material is silica.

19. The process of claim 1, wherein the first catalyst component and the second catalyst component are supported on a support material.

20. The process of claim 1, wherein the first catalyst component is supported on a first support material to form a supported first catalyst component, and the second catalyst component is supported on a second support material to form a supported second catalyst component, and the supported first catalyst component is mixed with the supported second catalyst component.

21. The process of claim 1, wherein the polymer comprises copolymers wherein the copolymer makes up from 1 wt % to 20 wt % of the polymer.
